(19) United States
(12) Patent Application Publication
(10) Pub. No.: US 2008/0304101 A1
(43) Pub. Date: Dec. 11, 2008

(54) SERVER AND PRINTER INTRODUCING METHOD UNDER THIN CLIENT ENVIRONMENT

(76) Inventor: Naoko SASASE, Atsugi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/123,961

(22) Filed: May 20, 2008

(30) Foreign Application Priority Data
Jun. 8, 2007 (JP) JP2007-153175

(51) Int. Cl. G06F 15/00

(52) U.S. Cl. 358/1.15

(57) ABSTRACT

There is described a server and printer introducing method under the thin client environment, in which the user can easily select such a printer that is located at a position in the vicinity of the client terminal device currently used by the user, from a large number of printers coupled to the network. The server includes: a printer information storage section to store printer-IP addresses, each of which corresponds to each of the plurality of printers, therein; and a control section that compares a client-IP address of the client terminal device with each of the printer-IP addresses so as to yield a comparison result, when the server receives a printer introduction request sent from the client terminal device, and then, selects a specific printer from the plurality of printers, based on the comparison result, so as to send printer information of the specific printer back to the client terminal device.

This application is based on Japanese Patent Application No. 2007-153175 filed on Jun. 8, 2007, with Japan Patent Office, the entire content of which is hereby incorporated by reference.

### BACKGROUND OF THE INVENTION

The present invention relates to a server having a function for providing information of a printer, currently coupled to a network, to a client terminal device, and specifically relates to the server under a thin client environment.

Recently, there has been proliferated in the market, a system to be activated under a thin client environment, in which each of the client terminal devices included in the system only has minimum functions, such as a display function, input-output accessing functions, etc., while the server conducts batch management processing of various kinds of resources, such as application software, files, etc.

Under the thin client environment, since the server provides all of the major functions to the client terminal device, it is possible for the server to provide the same operating environment (such as a desktop environment, etc.) to the client terminal device at any place within the system, as far as the client terminal device is connectable to the network at the place concerned. For instance, even when the user moves to a separate office from his home office, the user can operate the other client terminal device in the desktop environment same as that in his home office as usual.

In such the thin client environment as mentioned in the above, since all of the information concerning to the printers provided in the system are also registered in the server and controlled by the server, it is possible for the user to employ any one of the abovementioned printers, as far as the user is authorized to use the printer concerned. Accordingly, when the user wishes to use one of the printers residing on the network to conduct a printing operation, a printer list indicating the printers registered in the server can be displayed on the client terminal device concerned, so that the user can select a printer suitable for his printing purpose from the printer list. However, when a large number of printers are registered in the server, it is difficult for the user to determine which printer should be selected from the printer list.

Further, since a printer that is installed at a place, completely different form the installation place of the client terminal device currently used by the user, for instance, a printer installed in the adjacent building, is also included in the printer list currently displayed, there has arisen a problem that it is impossible for the user to appropriately select the printer installed at a place adjacent to the client terminal device currently used, or the user consumes much time and labor to conduct the operation for selecting the appropriate printer.

As a system that makes it possible for the user to select a printer, which is located at a place positionally convenient for the user, from a large number of printers included in the system, for instance, Tokkai 2001-142665 (Japanese Non-Examined Patent Publication) sets forth the system in which information in regard to positions of the printers and the client terminal devices included in the system are manually inputted in advance, or information in regard to positions of the printers and the client terminal devices are detected by employing the GPS (Global Positioning System) or the like, so as to display a specific printer list that indicates only the printers located adjacent to the client terminal device currently used by the user, based on the information acquired in the above.

However, in the abovementioned system in which the positions of the printer and the client terminal device are recognized by employing the GPS technology, the configurations of the apparatus and the system inevitably become complicated. Further, it is cumbersome and inconvenient for the user to conduct the operations for manually inputting the positional information.

### SUMMARY OF THE INVENTION

To overcome the abovementioned drawbacks in conventional systems, it is one of objects of the present invention to provide a server and printer introducing method under the thin client environment, in which the user can easily select such a printer that is located at a position in the vicinity of the client terminal device currently used by the user, from a large number of printers coupled to the network without complicating the configurations of various apparatus included in the system.

Accordingly, at least one of the objects of the present invention can be attained by the servers and the printer introducing method described as follows.

(1) According to a server reflecting an aspect of the present invention, the server to which a plurality of printers and at least a client terminal device are coupled through a network, comprises: a printer information storage section to store printer-IP addresses, each of which corresponds to each of the plurality of printers, therein; and a control section that compares a client-IP address of the client terminal device with each of the printer-IP addresses stored in the printer information storage section to yield a comparison result, when the server receives a printer introduction request sent from the client terminal device, and then, selects a specific printer from the plurality of printers, based on the comparison result, so as to send printer information of the specific printer back to the client terminal device.
(2) According to a server reflecting another aspect of the present invention, the server to which a plurality of printers and at least a client terminal device are coupled through a network, comprises: a printer information storage section to store printer-IP addresses, each of which corresponds to each of the plurality of printers, therein; and a control section that compares a client-IP address of the client terminal device with each of the printer-IP addresses stored in the printer information storage section to yield a comparison result, when the server receives a printer introduction request sent from the client terminal device, and then, determines a priority degree of each of the plurality of printers based on the comparison result, so as to send printer information of a specific printer, having the priority degree higher than those of other printers, back to the client terminal device prior to other printer information of the other printers.
(3) According to a printer introducing method reflecting still another aspect of the present invention, in the method for introducing a printer to a thin client terminal device in a thin client environment in which a server, at least a thin client terminal device and a plurality of printers are coupled to each other through a network, when the server receives a printer introduction request sent from the thin client terminal device, the server introduces such a specific printer that has a network address, an agreement degree of which with another network address of the thin client terminal device is higher than other agreement degrees of other printers, to the thin client terminal device, prior to the other printers.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows an exemplified system configuration of a thin client system embodied in the present invention;

FIG. 2 shows a block diagram indicating a rough configuration of a server included in a thin client system embodied in the present invention;

FIG. 3 shows an exemplary configuration of a client terminal device included in a thin client system embodied in the present invention;

FIG. 4 shows a relationship between a server and a client terminal device, and exemplary contents registered in a terminal device control table;

FIG. 5 shows a relationship between a server and a printer, and exemplary contents registered in a printer control table;

FIG. 6 shows a flowchart indicating an overall flow when conducting a printing operation in a thin client system embodied in the present invention;

FIG. 7 shows a flowchart indicating a processing procedure to be conducted by a server, when determining a displaying order of the printers;

FIG. 8 shows an example of a printer list screen;

FIG. 9 shows an example of a printer introduction screen; and

FIG. 10 shows a flowchart indicating a processing flow for determining a displaying order by employing status information and a number of jobs.

### DETAILED DESCRIPTION OF THE PREFERRED EMBODIMENT

Referring to the drawings, an embodiment of the present invention will be detailed in the following.

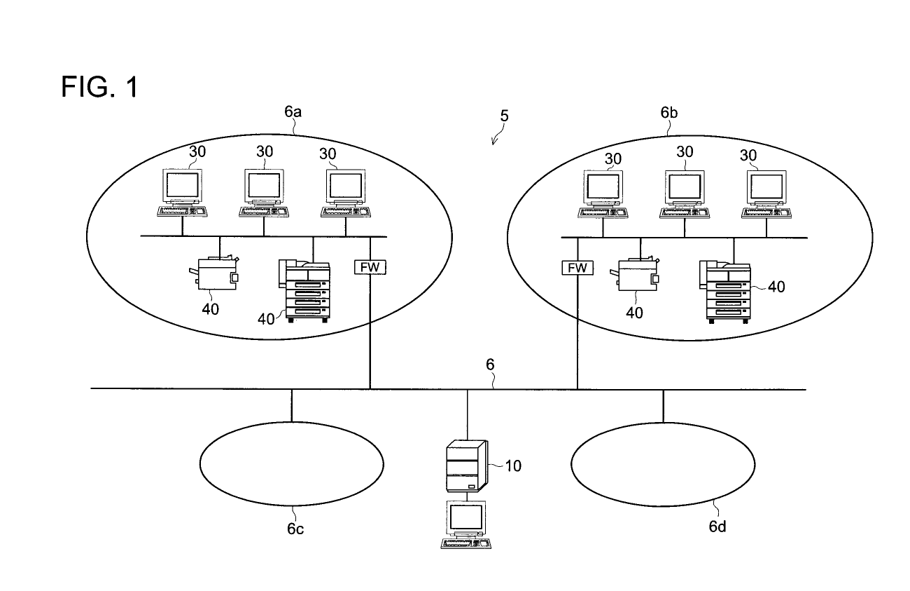

FIG. 1 shows an exemplified system configuration of a thin client system 5 embodied in the present invention. The thin client system 5 is constituted by a server 10, a client terminal device 30 and a printer 40, which are coupled to each other through a network 6. In the configuration shown in FIG. 1, a plurality of client terminal devices 30 (hereinafter, referred to as client terminal devices 30) and a plurality of printers 40 (hereinafter, referred to as printers 40) are coupled to each other in the thin client system 5.

Each of the client terminal devices 30 is a thin client provided with only functions of the minimum requirements, such as a displaying function, input-output accessing functions, a function for communicating with the server 10, or the like, while the server 10 manages and controls all of the resources, such as application software, files, etc. As indicated in the exemplified system configuration shown in FIG. 1, a plurality of sub-networks 6a, 6b, 6c, 6d are coupled to the network 6. Each of the sub-networks 6a, 6b, 6c, 6d serves as a management unit when the network managing operations are implemented by dividing a large scale network into a plurality of small networks. For instance, when the network 6 is established as a company private area network installed over certain company buildings, the sub-network 6a is defined as a sub-network installed in the third floor of the first building, the sub-network 6b is defined as another sub-network installed in the fourth floor of the first building, the sub-network 6c is defined as still another sub-network installed in the first floor of the second building, respectively.

Each of the sub-networks 6a, 6b, 6c, 6d is coupled to the network 6 through a fire wall FW, which also serves as a router. The client terminal devices 30 and the printer 40 are coupled to a LAN (Local Area Network) activated in each of the sub-networks 6a, 6b, 6c, 6d. Each of the client terminal devices 30 is provided with an IP address to couple it to the network 6. Further, each of the printers 40, serving as a network printer configured to be communicable with the server 10 through the network 6, is also provided with an IP address to couple it to the network 6. Each of IP addresses is constituted by a network address section for specifying the sub-network and a host address section for individually identifying each of the client terminal devices or each of the printers, and a value, representing what number of bits from MSB in the IP address belong to the network address section, is called a subnet mask.

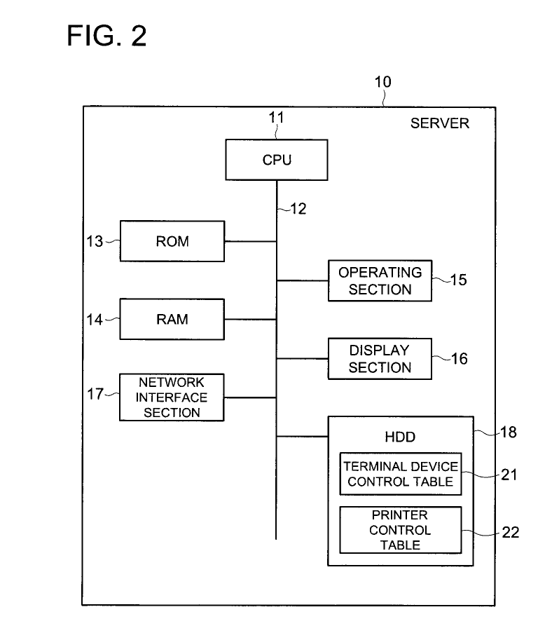

FIG. 2 shows a block diagram indicating a rough configuration of the server 10. As shown in FIG. 2, the server 10 is constituted by a CPU (Central Processing Unit) 11 to totally control operations to be conducted by the server 10, a ROM (Read Only Memory) 13, a RAM (Random Access Memory) 14, an operating section 15, a display section 16, a network interface section 17, an HDD (Hard Disc Drive) 18, etc., which are coupled to each other through a bus 12. The ROM 13 and the HDD 18 store in advance various kinds of programs and stationary data therein, while the CPU 11 executes the abovementioned programs so as to implement various kinds of functions to be conducted by the server 10. The RAM 14 serves as a working memory for temporarily storing data, etc., when the CPU 11 executes the programs concerned.

The operating section 15 includes a keyboard, a mouse (pointing device), etc., so as to accept inputting operations conducted by the system manager or the regular user. The display section 16 is constituted by a LCD (Liquid Crystal Display), etc., so as to display various kinds of information to be utilized by the system manager or the regular user. Further, the network interface section 17 implements communication controlling operations for bilaterally communicating with the external devices, such as the client terminal devices 30, the printers 40, etc., through the network 6.

The HDD 18 serves as a nonvolatile mass storage device, in which various kinds of application programs to be provided to each of the client terminal devices 30, various kinds of driver programs to be provided to each of the printers 40, etc., are stored. In addition, the files created by each of the client terminal devices 30, the setting contents (for instance, setting contents representing the desktop environment, user information, etc.) established by each of the users are also stored in the HDD 18. Further, a terminal device control table 21 and a printer control table 22 are created and stored in the HDD 18, which are detailed later on. In this connection, it is applicable that the server 10 is configured by utilizing a general purpose computer.

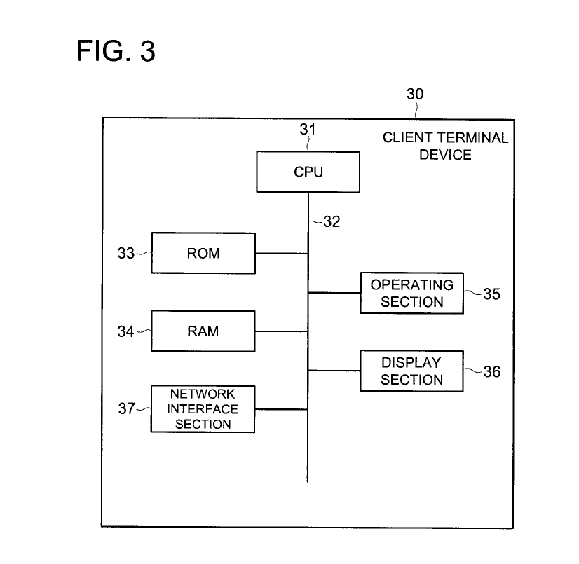

FIG. 3 shows an exemplary configuration of the client terminal device 30. As shown in FIG. 3, the client terminal device 30 is constituted by a CPU 31 to control operations to be conducted by the client terminal device 30, a ROM 33, a RAM 34, an operating section 35, a display section 36, a network interface section 37, etc., which are coupled to each other through a bus 32. The ROM 33 stores computer programs of minimum requirements for making the client terminal device 30 to be operated as the thin client terminal device (for instance, such as user interface software, a communication program, or the like), therein. The CPU 31 executes the programs stored in the CPU 31, so as to implement various kinds of functions to be conducted as the thin client terminal device. The RAM 34 serves as a working memory for temporarily storing data, etc.

The operating section 35 includes a keyboard, a mouse (pointing device), etc., so as to accept inputting operations conducted by the user. The display section 36 is constituted by a LCD (Liquid Crystal Display), etc., so as to display various kinds of screens, such as an operating screen, etc., to be utilized by the user. Further, the network interface section 37 implements communication controlling operations for bilaterally communicating with the server 10 through the network 6.

In the thin client system 5, for instance, when the user of the client terminal device 30 uses a kind of application program, the application program concerned is actually executed on the server 10. Concretely speaking, the server 10 transmits image data, representing each of the screens in regard to the application program instructed by the client terminal device 30, to the client terminal device 30, and then, based on the image data received, the client terminal device 30 displays the operating screen, etc., onto the display section 36. Further, the client terminal device 30 transmits the operating contents inputted by the user from the operating section 35, and then, according to the operating contents received, the server 10 executes the application program concerned. Namely, the thin client system 5 is operated according to such the flow as mentioned in the above.

Accordingly, it is possible for the user to login the system from any one of the client terminal devices 30 located at various sites within the network 6, and the utility environment for the user concerned, such as the specific desktop environment established by the user, etc., can be also reproduced on the client terminal device 30 currently logged in by the user concerned.

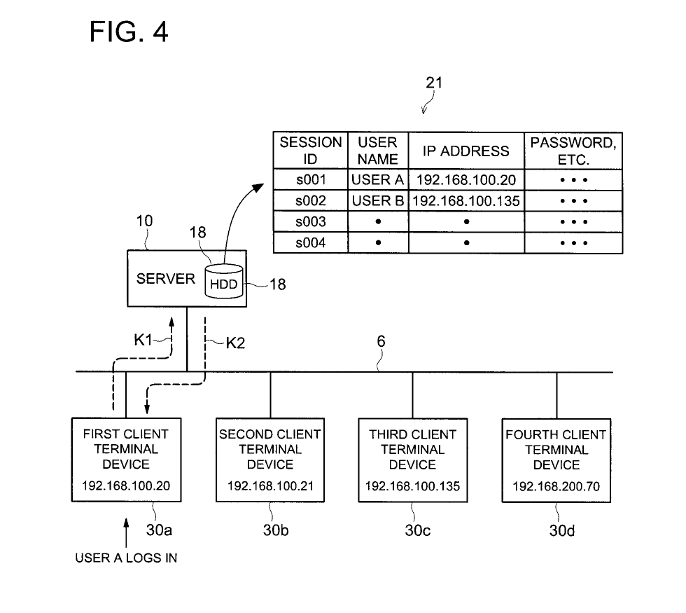

FIG. 4 shows a relationship between the server 10 and the client terminal device 30, and exemplary contents registered in the terminal device control table 21. The IP addresses, each of which is unique corresponding to each of the client terminal devices 30, are allotted to the client terminal devices 30, respectively. For instance, when a user A uses a first client terminal device 30a, user information of the user A (for instance, the user ID and the password) and the IP address of the first client terminal device 30a are transmitted from the first client terminal device 30a to the server 10 (Flow K1).

Receiving the user information and the IP address abovementioned, the server 10 registers the session ID of the session established between the first client terminal device 30a and the server 10, the user name (herein, the user A) and the IP address of the first client terminal device 30a, into the terminal device control table 21, while correlating them with each other. Further, the server 10 reflects the setting contents (such as the operating environment, etc.), established by the user A and stored in the HDD 18, onto the operations in regard to the first client terminal device 30a. For instance, the server 10 reproduces the desktop environment of the user A, and transmits the image data representing the desktop environment to the first client terminal device 30a, so that the screens of the desktop environment established by the user A are displayed on the first client terminal device 30a (Flow K2).

When assuming that the user A logins the system from the fourth client terminal device 30d shown in FIG. 4, the user A is registered into the terminal device control table 21 while correlating the user A with the IP address of the client terminal device 30d, and accordingly, the setting contents established by the user A are reflected onto the operations to be conducted by the client terminal device 30d.

In this connection, it is not necessary that the IP address of the client terminal device 30 should be allotted as a stationary IP address. It is also applicable that the IP address of the client terminal device 30 is acquired from the DHPC (Dynamic Host Configuration Protocol) server every time when the user uses the client terminal device 30 concerned.

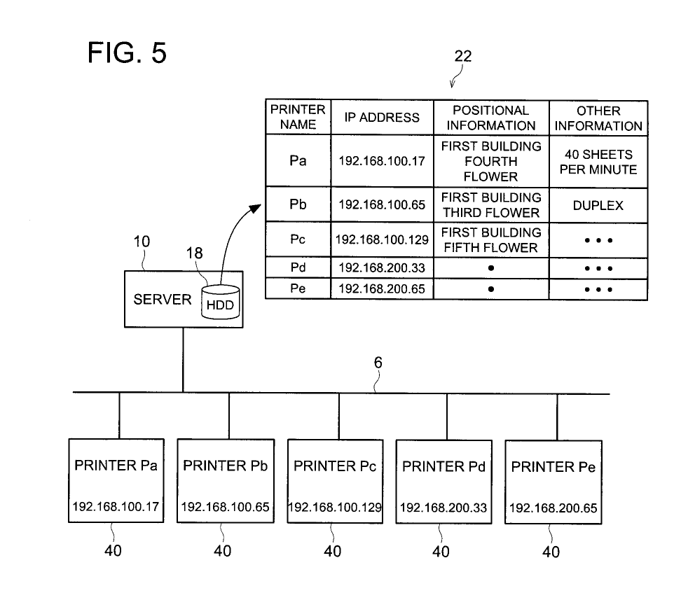

FIG. 5 shows a relationship between the server 10 and the printer 40, and exemplary contents registered in the printer control table 22. The IP addresses, each of which is unique and stationary corresponding to each of the printers 40, are allotted to the printers 40, respectively. A name of the printer concerned, positional information, an apparatus model name, other information indicating features of the printer concerned (for instance, a processing speed, possible or impossible for conducting a duplex printing, information indicating color or monochrome image forming apparatus), etc., are registered into the printer control table 22 in advance, while correlating them with the IP address of each of the printers 40. The operation of registering the abovementioned information into the printer control table 22 can be achieved by, for instance, operating the operating section 15 of the server 10. Alternatively, it is also applicable that the authorized manager or the like operates the operating section 35 of the client terminal device 30 so as to register the abovementioned information.

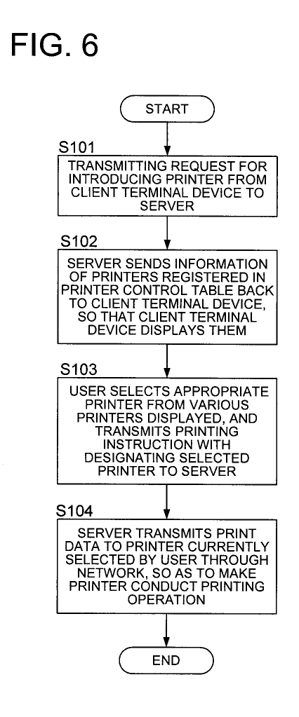

FIG. 6 shows a flowchart indicating a procedure of printing an image based on a file created by executing an application program, etc. When the user wish to implement a printing operation based on the file, etc., created by executing the application program, the user operates the client terminal device 30 so as to transmit a request for introducing a printer to be employed for the current printing operation to the server 10 (Step S101). Receiving the request, the server 10 sends the information of the printers 40, registered in the printer control table 22, back to the client terminal device 30 concerned, so that the client terminal device 30 displays them as the printer list or the like (Step S102). The user selects an appropriate printer from various printers displayed on the printer list, and then, transmits a printing instruction with designating the selected printer to the server 10 (Step S103). Receiving the printing instruction, the server 10 transmits the print data concerned, to the printer 40 currently selected by the user through the network 6, so as to make the concerned printer 40 conduct the printing operation based on the print data transmitted (Step S104).

It is applicable that the system is so constituted that, when the printing instruction is transmitted from the client terminal device 30 to the server 10, the printer introduction request is transmitted prior to the transmission of the actual printing instruction, or by conducting another operation to be conducted separately from the transmitting operation of the printing instruction (such as an operation for the purpose of the introduction of the printer itself, etc.), from the client terminal device 30 to the server 10.

According to the thin client system 5 embodied in the present invention, when introducing the printers 40 to a specific client terminal device 30, the printer information of the printer, which is located at a position in the vicinity of the client terminal device 30 concerned, is prioritized in the displaying order of the printers registered in the printer control table 22. With respect to this prioritized display mentioned in the above, the operations, to be conducted in the thin client system 5, will be detailed in the following.

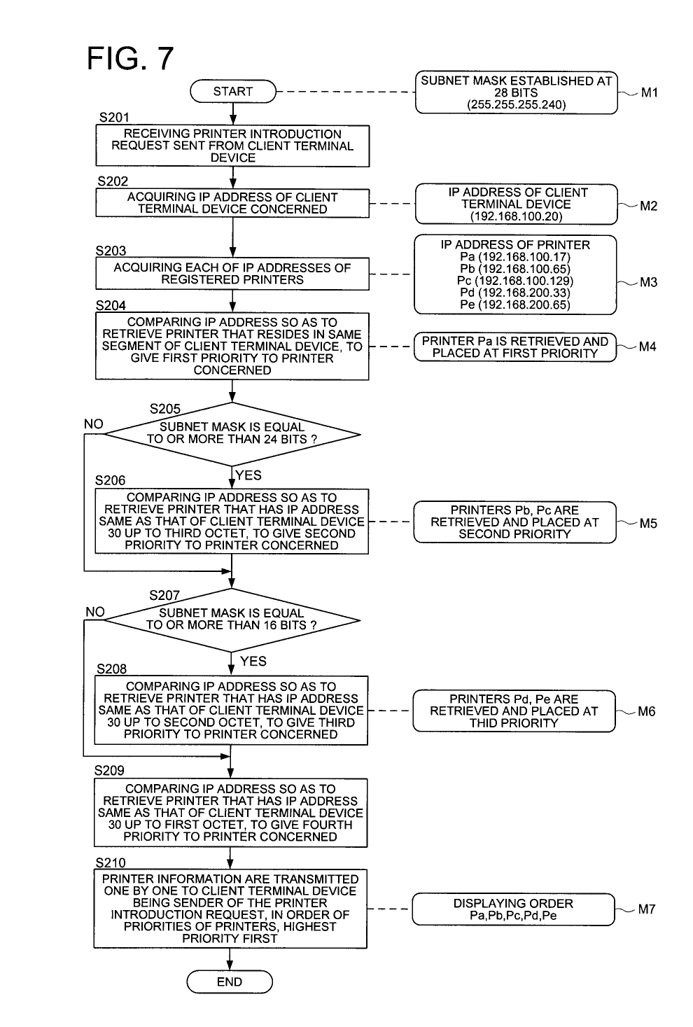

FIG. 7 shows a flowchart of the processing procedure to be conducted by the server 10, when determining the displaying order of the printers. In this connection, a concrete example of each processing step is indicated in each of the blocks located at the right column of the flowchart shown in FIG. 7. Further, in the example shown in FIG. 7, it is assumed that the subnet mask is established at 28 bits (255.255.255.240) (M1).

Receiving the printer introduction request sent from the client terminal device 30 (Step S201), the server 10 acquires the IP address of the client terminal device 30 being a current sender of the printer introduction request concerned (Step S202, M2). It is applicable that the server 10 acquires the IP address from the terminal device control table 21, or the IP address that is informed by the client terminal device 30 when the client terminal device 30 accesses the server 10.

Further, the server 10 acquires each of the IP addresses of the printers coupled to the network 6 from the printer control table 22 (Step S203, M3). In the concrete example shown in FIG. 7, the IP address of the client terminal device 30 is 192.168.100.20, while the IP addresses of the printers Pa, Pb, Pc, Pd and Pe are acquired as 192.168.100.17, 192.168.100.65, 192.168.100.129, 192.168.200.33 and 192.168.200.65, respectively.

The server 10 compares the IP address of the client terminal device 30 concerned, with the IP address of each of the printers 40 with respect to the network address section (28 bits from the MSB indicated by the subnet mask), so as to retrieve such a printer 40 that has a value of the network address section being same as that of the client terminal device 30 (namely, both segments are the same relative to each other), and gives the first priority (the first position) to the concerned printer 40 retrieved in the above (Step S204, M4). In the concrete example shown in FIG. 7, the printer Pa is retrieved and placed at the first priority.

Successively, the server 10 determines whether or not the subnet mask is equal to or more than 24 bits (Step S205). When determining that the subnet mask is equal to or more than 24 bits (Step S205; Yes), the server 10 compares the IP address of the client terminal device 30 concerned, with the IP address of each of the residual printers 40 other than the first printer 40 prioritized to the first priority, so as to retrieve such a printer 40 that has an IP address same as that of the client terminal device 30 up to the third octet (or 3 bytes), and gives the second priority (the second position) to the concerned printer 40 retrieved in the above (Step S206, M5). In the concrete example shown in FIG. 7, since the subnet mask is 28 bits, namely, more than 24 bits, the processing of Step S206 is implemented, and as a result, the printers Pb, Pc are retrieved and placed at the second priority.

Still successively, the server 10 determines whether or not the subnet mask is equal to or more than 16 bits (Step S207). When determining that the subnet mask is equal to or more than 16 bits (Step S207; Yes), the server 10 compares the IP address of the client terminal device 30 concerned, with the IP address of each of the residual printers 40 other than the first and second printers 40 prioritized to the first priority and the second priority, so as to retrieve such a printer 40 that has an IP address same as that of the client terminal device 30 up to the second octet (or 2 bytes), and gives the third priority (the third position) to the concerned printer 40 retrieved in the above (Step S208, M6). In the concrete example shown in FIG. 7, since the subnet mask is 28 bits, namely, more than 16 bits, the processing of Step S208 is implemented, and as a result, the printer Pd, Pe are retrieved and placed at the third priority.

Still successively, the server 10 compares the IP address of the client terminal device 30 concerned, with the IP address of each of the residual printers 40 other than the first, second and third printers 40 prioritized to the first priority, the second priority and the third priority, so as to retrieve such a printer 40 that has an IP address same as that of the client terminal device 30 up to the first octet (or 1 byte), and gives the fourth priority (the fourth position) to the concerned printer 40 retrieved in the above (Step S209).

Yet successively, the printer information of the printers 40 are transmitted one by one to the client terminal device 30, serving as the sender of the printer introduction request, in the order of the priorities of the printers 40, highest priority first, determined in the abovementioned procedure (Step S210), and then, the processing procedure is finalized (END). In the concrete example shown in FIG. 7, the displaying order of the printer information is determined as the order of printer Pa, printer Pb, printer Pc, printer Pd and printer Pe. In this connection, since the priorities of printer Pb and printer Pc are the same as each other, the displaying order of them is changeable relative to each other. Further, from the same reason as mentioned in the above, the displaying order of printer Pd and printer Pe is also changeable relative to each other.

When the network address section of the IP address of the client terminal device 30 is the same as that of the printer 40, it can be estimated that both of them, concerned, fundamentally belong to the same sub-network (or the same segment), and are coupled to the network extended from the same router. In addition, it can be also estimated that the position at which the network is divided as the same segment is such a place that is positionally adjacent place, such as the same floor, etc. Accordingly, as shown in FIG. 7, by setting the priority of the printer 40, which has a higher agreement degree between the IP address (network address section) of the client terminal device 30 and that of the printer 40, at a higher priority, it becomes possible to give a priority to the printer 40, located in the vicinity of the client terminal device 30 concerned, so that the printer information of the printer 40 having a higher priority is prioritized in the display screen.

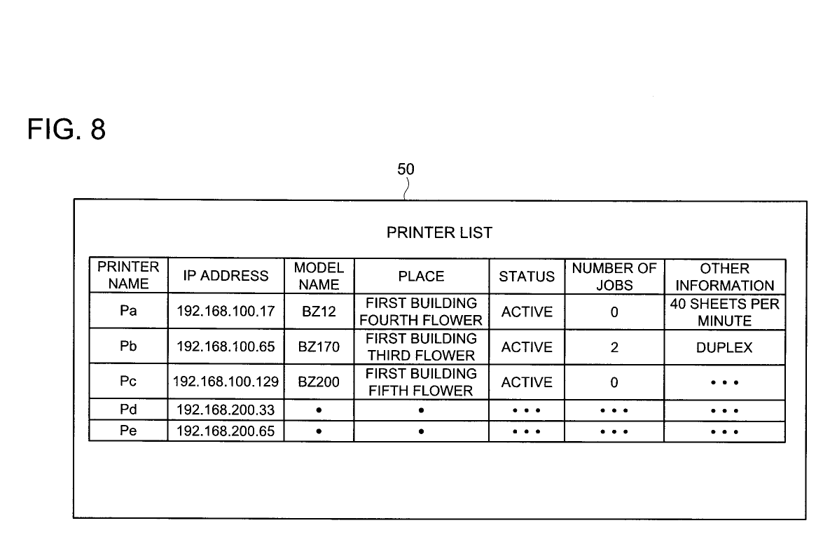

FIG. 8 shows an example of a printer list screen 50 in which the printer information of the printers 40 are listed according to the priority order mentioned in the above. In the printer list screen 50 shown in FIG. 8, the printer information of the printers 40 are indicated from the top line to the bottom line, corresponding to the order of high-to-low priority. Further, the information of each of the printers 40, such as a model name, an installation site, a status, a number of jobs, etc., are also indicated. The model name and the site information are acquired from the printer control table 22. The status information indicates a current status of the printer concerned, namely, indicates any one of “ACTIVE”, “READY”, “PRINT DISABLE” due to a certain error, “POWER OFF/ON”, etc. The number of jobs indicates a number of printing jobs, which are currently reserved in the printer concerned, to wait for the printout operation. The server 10 acquires the status information from each of the printers 40 through the network 6. Further, the number of jobs is controlled by employing an output queue, etc., in the server 10.

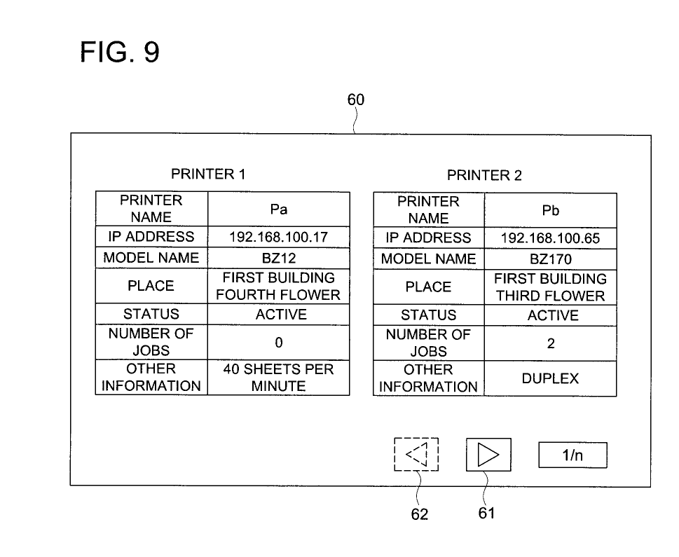

FIG. 9 shows an example of a printer introduction screen 60, which displays the printer information every predetermined number of the printers 40, in the order of high-to-low priority. In the printer introduction screen 60 shown in FIG. 9, the printer information for two printers are displayed at a time. By depressing an upward page scrolling key 61 located at the lower space of the screen, the screen is scrolled toward the next printer having a priority lower than previous one (this is achieved by transmitting screen information of the next screen from server 10 to the client terminal device 30 concerned), while, by depressing a downward page scrolling key 62 located at the left side of the upward page scrolling key 61, the screen is scrolled toward the previous printer having a priority higher than next one.

As mentioned in the above, by displaying printer information for every several sets of printers on the screen, it becomes possible to widen the area for displaying the printer information per one printer, and accordingly, it also becomes possible to display the printer information in an easily recognizable manner. Further, since it can be assumed that the user usually determines a specific printer as the printing destination by selecting it from several candidate printers having high priorities, no inconvenience for the user will arise, even when the user uses the screen in which printer information is displayed for every several sets of printers having high priorities. Although every two printers are displayed in the screen shown in FIG. 9, it is possible to establish a number of printers to be displayed on the printer introduction screen 60 at a time, as needed. Accordingly, it is applicable that the abovementioned number of printers is established as any one of one printer, three printers, four printers, etc. Alternatively, it is also applicable that the system is so constituted that a number of printers to be displayed on the single screen is settable by the system manager or a regular user.

In this connection, it is applicable that the displaying priority is determined by judgment elements including the current status (available or unavailable status, etc.) and/or the waiting job status (a number of jobs waiting for the printout operation) of the printer concerned. For instance, when a plurality of printers are installed in the same network (sub-network) and the priority of each printer is determined only by employing its IP address, the plurality of printers installed in the same network have the same priority. At this time, if the displaying priority is determined by also considering the current status, the waiting job status, etc., with respect to the printer concerned, in addition to the IP address, it becomes possible to select an appropriate printer in more effective way than ever.

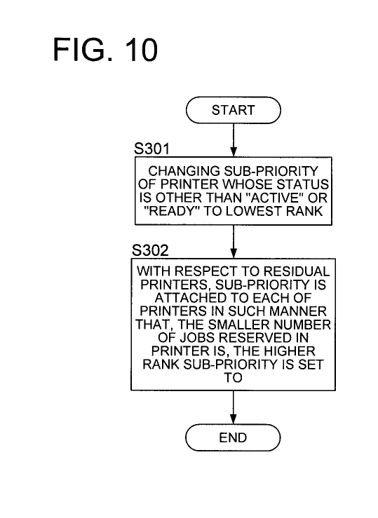

FIG. 10 shows a flowchart indicating a processing flow for determining a further detailed priority order (displaying order) by employing the status information and the number of jobs, which is to be conducted after the provisional priority order is determined on the basis of the IP addresses of the printers 40. In this processing, a finer priority order (hereinafter, referred to as a sub-priority) is determined with respect to each of the priorities determined on the basis of the IP addresses. Initially, the sub-priority of the printer whose status is other than “ACTIVE” or “READY” is changed to the lowest rank (Step S301). In other words, the priority level of the printer, which is currently in a print disable state due to occurrence of a certain error, an OFF status of its power source, etc., is made to be lowered.

Successively, with respect to the residual number of printers, the sub-priority is attached to each of the printers in such a manner that, the smaller the number of jobs reserved in the printer is, the higher rank the sub-priority is set to (Step S302). For instance in the printer list screen 50 shown in FIG. 8, although printers Pb and Pc are currently indicated in the order of Pb to Pc, from top to bottom of the list, when the sub-priority is determined in order of small-to-large number of jobs waiting the printout operation, the order of Pb to Pc is changed to the order of Pc to Pd as the actual displaying order in the list.

Specifically, when the printer information is displayed for every several sets of printers as indicated in the printer introduction screen 60 shown in FIG. 9, by applying the sub-priority, it becomes possible to swiftly introduce an appropriate printer to the user. For instance, when the displaying order is determined as Pa, Pc, Pb , by taking the sub-priority into account, the printer information of the printer Pa and printer Pc are displayed on the initial screen, and accordingly, it becomes possible to effectively introduce to the user such a printer from which the user can acquire the print products earlier than from other printers, so as to urge the user to swiftly select the desired printer.

In this connection, with respect to the currently unavailable printer, it is applicable that the system is so constituted that the priority of such the printer is lowered to a further lower rank exceeding the provisional priority determined on the basis of the IP address. For instance, even if the provisional priority determined on the basis of the IP address is the first priority, when the printer concerned currently enters in an unavailable state due to occurrence of a certain error, it is applicable that the priority of the printer concerned is set at the lowest level (for instance, the fifth priority), or excluded from the displaying objects.

Further, it is also applicable that, by taking not only the number of jobs, but also the printing velocity of each of the printers 40, into account, the faster the print products can be acquired (or the shorter the time required to complete the printing operation is), the higher level the provisional priority and the sub-priority of the printer concerned is set at. Alternatively, it is also applicable that the system is so constituted that a plurality of evaluation items, including an agreement degree between the IP addresses, a time required for completing the printing operation, etc., are provided so as to give evaluation points to each of them, and then, the priority of each of the printers 40 is determined by employing the total sum of the evaluation points.

Although the preferred embodiments of the present invention have been described in the foregoing by referring to the drawings, the scope of the present invention is not limited to the above-described embodiments. Modifications and additions made by a skilled person without departing from the spirit and scope of the invention shall be included in the scope of the present invention.

For instance, although the thin client environment has been exemplified in the embodiment described in the above, the present invention is also applicable for a normal server-client system to be activated in an environment other than the thin client environment.

Further, although the above-described embodiment is so constituted that the printers 40 are prioritized on the basis of the agreement degree between the IP addresses, the status of the apparatus concerned, the number of jobs, etc., and then, the printer information of the printers 40 are displayed (introduced) one by one in the order of priority, high to low, it is also applicable that the scope of the printers to be introduced to the client terminal device 30 b by comparing the IP address is limited to only such printers that fulfill a certain prescribed standard. For instance, it is applicable that only such printers that the network address section of their IP addresses coincides with that of the client terminal device 30 being the current sender of the printer introduction request, namely, only such printers that resides in the same segment (sub-network), are selected and introduced to the client terminal device 30.

Still further, it is also applicable that the system is so constituted that, by using the prioritizing operation and the selecting operation together, for instance, so as to select the printers 40 up to the second priority, the printer having the higher priority overrides the other printers in the displaying order of them.

Yet further, although the terminal device control table 21 and the printer control table 22 are provided as the separate tables in the aforementioned embodiment, it is also applicable that both the tables are merged into a single table. Further, in the configuration that, when receiving the printer introduction request sent from the client terminal device 30, the IP address transmitted by the client terminal device 30 at that accessing time is acquired, it is unnecessary to provide the terminal device control table 21 for the purpose of acquiring the IP address.

According to the server and printer introducing method under the thin client environment, embodied in the present invention, it becomes possible for the user to easily select such a printer that is located at a position in the vicinity of the client terminal device currently used by the user, from a large number of printers coupled to the network.

While the preferred embodiments of the present invention have been described using specific term, such description is for illustrative purpose only, and it is to be understood that changes and variations may be made without departing from the spirit and scope of the appended claims.

What is claimed is:

1. A server to which a plurality of printers and at least a client terminal device are coupled through a network, comprising:
a printer information storage section to store printer-IP addresses, each of which corresponds to each of the plurality of printers, therein; and
a control section that compares a client-IP address of the client terminal device with each of the printer-IP addresses stored in the printer information storage section to yield a comparison result, when the server receives a printer introduction request sent from the client terminal device, and then, selects a specific printer from the plurality of printers, based on the comparison result, so as to send printer information of the specific printer back to the client terminal device.

2. The server of claim 1,
wherein the server is activated in a thin client environment.

3. The server of claim 1,
wherein the server compares a network address section included in the client-IP address with that included in each of the printer-IP address.

4. The server of claim 1,
wherein the control section controls the printer information storage section so as to further store positional information of the plurality of printers in the printer information storage section while correlating each of the printer information with each of the printer-IP addresses; and
wherein the control section also sends the positional information of the specific printer in addition to the printer information back to the client terminal device.

5. The server of claim 1,
wherein the control section selects the specific printer, based on the comparison result and other decision factors including a status whether each of the plurality of printers is available or unavailable and/or an output waiting jobs status of each of the plurality of printers.

6. A server to which a plurality of printers and at least a client terminal device are coupled through a network, comprising:
a printer information storage section to store printer-IP addresses, each of which corresponds to each of the plurality of printers, therein; and
a control section that compares a client-IP address of the client terminal device with each of the printer-IP addresses stored in the printer information storage section to yield a comparison result, when the server receives a printer introduction request sent from the client terminal device, and then, determines a priority degree of each of the plurality of printers based on the comparison result, so as to send printer information of a specific printer, having the priority degree higher than those of other printers, back to the client terminal device prior to other printer information of the other printers.

7. The server of claim 6,
wherein the server is activated in a thin client environment.

8. The server of claim 6,
wherein the server compares a network address section included in the client-IP address with that included in each of the printer-IP address.

9. The server of claim 6,
wherein the control section controls the printer information storage section so as to further store positional information of the plurality of printers in the printer information storage section while correlating each of the printer information with each of the printer-IP addresses; and
wherein the control section also sends the positional information of the specific printer in addition to the printer information back to the client terminal device.

10. The server of claim 6,
wherein the control section sends printer information back to the client terminal device for every several number of printers in order of the priority degree of the plurality of printers, high to low.

11. The server of claim 6,
wherein the control section determines the priority degree, based on the comparison result and other decision factors including a status whether each of the plurality of printers is available or unavailable and/or an output waiting jobs status of each of the plurality of printers.

12. A method for introducing a printer to a thin client terminal device in a thin client environment in which a server, at least a thin client terminal device and a plurality of printers are coupled to each other through a network;
wherein, when the server receives a printer introduction request sent from the thin client terminal device, the server introduces such a specific printer that has a network address, an agreement degree of which with another network address of the thin client terminal device is higher than other agreement degrees of other printers, to the thin client terminal device, prior to the other printers.
